(19) United States
(12) Patent Application Publication
(10) Pub. No.: US 2007/0280326 A1
(43) Pub. Date: Dec. 6, 2007

(54) External cavity laser in thin SOI with monolithic electronics

(75) Inventors: David Piede, Allentown, PA (US); Margaret Ghiron, Allentown, PA (US); Prakash Gothoskar, Allentown, PA (US); Robert Keith Montgomery, Easton, PA (US)

Correspondence Address: Wendy W. Koba, Esq., PO Box 556, Springtown, PA, 18081, US

(73) Assignee: SiOptical, Inc.

(21) Appl. No.: 11/637,979

(22) Filed: Dec. 13, 2006

Related U.S. Application Data
(60) Provisional application No. 60/750,948, filed on Dec. 16, 2005.

(51) Int. Cl. H01S 3/10; H01S 3/08

(52) U.S. Cl. 372/102; 372/92; 372/99; 372/20

(57) ABSTRACT

An ECL laser structure utilizes an SOI-based grating structure coupled to the external gain medium to provide lasing activity. In contrast to conventional Bragg grating structures, the grating utilized in the ECL of the present invention is laterally displaced (i.e., offset) from the waveguide (in most cases, a rib or strip waveguide) comprising the laser cavity. The grating is formed in an area with higher contrast ratio between materials (silicon and oxide) and thus requires a lesser amount of optical energy to reflect the selected wavelength, and can easily be formed using well-known CMOS fabrication processes. The pitch of the grating (i.e., the spacing between adjacent grating elements) and the refractive index values of the grating materials determine the reflected wavelength (also referred to as the “center wavelength”). A thermally conductive strip is disposed alongside the grating to adjust/tune the center wavelength of the grating, where the application of an electric current to the thermally conductive strip will heat the strip and transfer this heat to the grating. The change of temperature of the grating will modify the refractive indexes of the grating materials and as a result change its center wavelength.

### CROSS-REFERENCE TO RELATED APPLICATIONS

The present application claims the benefit of US Provisional Application No. 60/750,948, filed Dec. 16, 2005.

### TECHNICAL FIELD

The present invention relates to an SOI-based external cavity laser (ECL) and, more particularly, to an SOI-based ECL that utilizes a grating structure offset from the waveguiding region to reduce its effect on the propagating optical mode.

### BACKGROUND OF THE INVENTION

The need for fast and efficient optical-based technologies is increasing as Internet data traffic growth rate is overtaking voice traffic, pushing the need for fiber optical communications. Transmission of multiple optical channels over the same fiber in the dense wavelength-division multiplexing (DWDM) system provides a simple way to use the unprecedented capacity (signal bandwidth) offered by fiber optics. Commonly-used optical components in the system include WDM transmitters and receivers, optical filters such as diffraction gratings, thin-film filters, fiber Bragg gratings, arrayed-waveguide gratings, optical add/drop multiplexers, and “tunable” lasers. In general, lasers are defined as tunable when their emission wavelength can be readily adjusted and set by the user to operate at any of the several prescribed available emission wavelengths associated with WDM systems.

One type of laser source for fiber optic communications systems is what is known as an external cavity laser diode (ECLD). An ECLD includes a laser diode chip in combination with an external waveguide formed with a grating. The grating acts as a filter and limits the output wavelengths to a band that is much narrower than the laser diode's inherent range of wavelengths. A particular type of ECLD uses a fiber Bragg Grating (FBG). It is known that the output wavelength of an ECLD depends on the optical pitch of the grating, which depends on the geometric pitch of the grating and the refractive index of the fiber in the grating region. The geometric pitch and refractive index vary with temperature in accordance with the thermal and material characteristics of the fiber.

### SUMMARY OF THE INVENTION

The present invention is directed to an external cavity laser and, more particularly, to an SOI-based ECL that utilizes a grating structure offset from the waveguiding region within the SOI substrate to reduce the effects of the grating on the propagating optical mode.

In accordance with the present invention, an ECL laser structure utilizes an SOI-based grating structure that is coupled to the external gain medium to define a second cavity endface so as to provide lasing activity. In contrast to conventional Bragg grating structures, the grating utilized in the ECL of the present invention is laterally displaced (i.e., offset) from the waveguide (in most cases, a rib or strip waveguide). That is, the grating is formed in an area with higher contrast ratio between materials (silicon and oxide) and thus requires a lesser amount of optical mode overlap to provide the desired filtering operation. The pitch of the grating (i.e., the spacing between adjacent grating elements) and the refractive index values of the grating materials determine the filtered wavelength (also referred to as the “center wavelength”). A thermally conductive strip is disposed alongside the grating to adjust/tune the center wavelength of the grating, where the application of an electric current to the thermally conductive strip will heat the strip and transfer this heat to the grating. The change of temperature of the grating will modify the refractive indexes of the grating materials and as a result change its center wavelength.

In one embodiment, a single grating is formed to be longitudinally disposed along one side of the optical waveguiding structure. In an alternative embodiment, a pair of gratings is used, with one grating formed on each side of the waveguide. The grating(s) may also be apodized to reduce reflections at the input and other of the grating(s).

A multiple number of such offset gratings may be disposed adjacent to a like number of waveguides, where each grating may be separately “tuned” to reflect a different wavelength, thus forming a multiple number of propagating signals from a single ECL source.

It is an advantage of the arrangement of the present invention that the required grating structures comprise alternating sections of silicon and oxide, allowing for the inventive arrangement to easily be fabricated in an SOI substrate utilizing conventional CMOS processing technology.

Other and further embodiments of the present invention will become apparent during the course of the following discussion and by reference to the accompanying drawings.

### BRIEF DESCRIPTION OF THE DRAWINGS

Referring to the drawings,

FIG. 1 is a block diagram of a first embodiment of the present invention;

FIG. 2 is a block diagram of a second, alternative embodiment of the present invention;

FIG. 3 is a cut-away isometric view of an exemplary wavelength selective element formed in accordance with the present invention;

FIG. 4 is a top view of the arrangement of FIG. 3;

FIG. 5 illustrates an alternative embodiment of the present invention, in this case utilizing a pair of grating structures disposed in an off-set configuration on either side of the propagating waveguide;

FIG. 6 is a top view of the arrangement of FIG. 5;

FIG. 7 is a top view of an exemplary adiabatic version of a grating arrangement formed in accordance with the present invention;

FIG. 8 illustrates an exemplary WDM arrangement formed in accordance with the present invention, where a single ECL device is utilized to generate and provide a plurality of output signals operating at different, unique wavelengths; and

FIG. 9 illustrates an alternative WDM embodiment, utilizing gratings operating at different center wavelengths, with phase control elements utilized to provide tuning.

### DETAILED DESCRIPTION

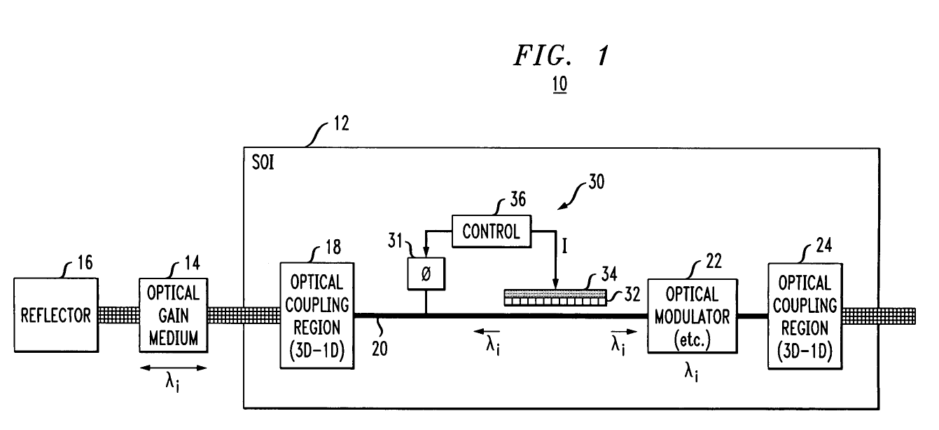

FIG. 1 contains a high-level block diagram of an exemplary SOI-based external cavity laser (ECL) 10 formed in accordance with the present invention. It is a significant aspect of the present invention that the majority of the laser components are formed as a monolithic arrangement of elements within a single SOI structure 12, utilizing conventional, well-known CMOS fabrication processes. As shown, only optical gain medium 14 and cavity endface reflector 16 are formed “off-chip”. Referring in particular to SOI structure 12, the remaining components of ECL 10 are identified as comprising an optical coupling region 18 for converting between a three-dimensional optical signal (associated with optical gain medium 14) and a second cavity termination defined by a Bragg grating 32 that interacts with a one-dimensional optical signal as it propagates through a single mode waveguide 20.

In accordance with the present invention, a tunable wavelength selective element 30 is utilized in conjunction with Bragg grating 32 to select a particular wavelength, denoted λᵢ, that will be defined as the “center wavelength” of the system and reflected back along waveguide 20 and into optical gain medium 14 to generate a lasing output at this selected wavelength. The amplified signal at wavelength λᵢ is thereafter applied as an input to the optical communication device, shown in the arrangement of FIG. 1 as an optical modulator 22. If necessary, a subsequent output optical coupling element 24 may be used to direct the modulated (or otherwise modified) optical signal out of single mode waveguide 20 (propagating as a one-dimensional signal) and into a three-dimensional, free space optical communication environment.

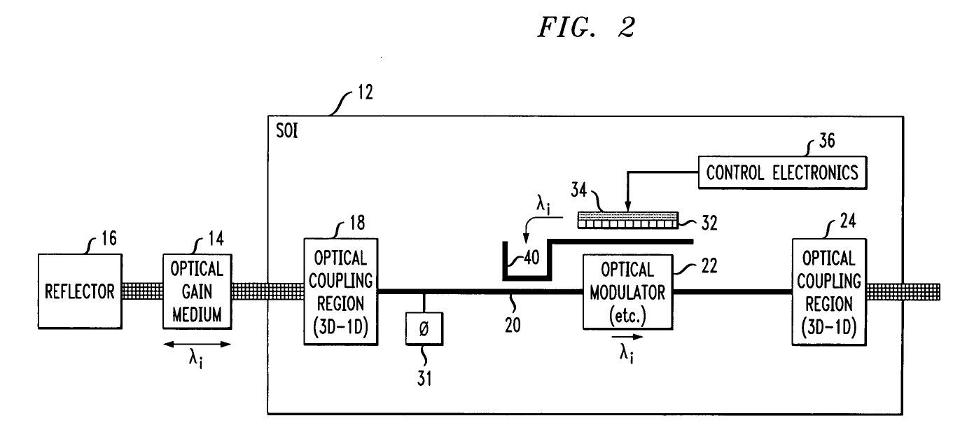

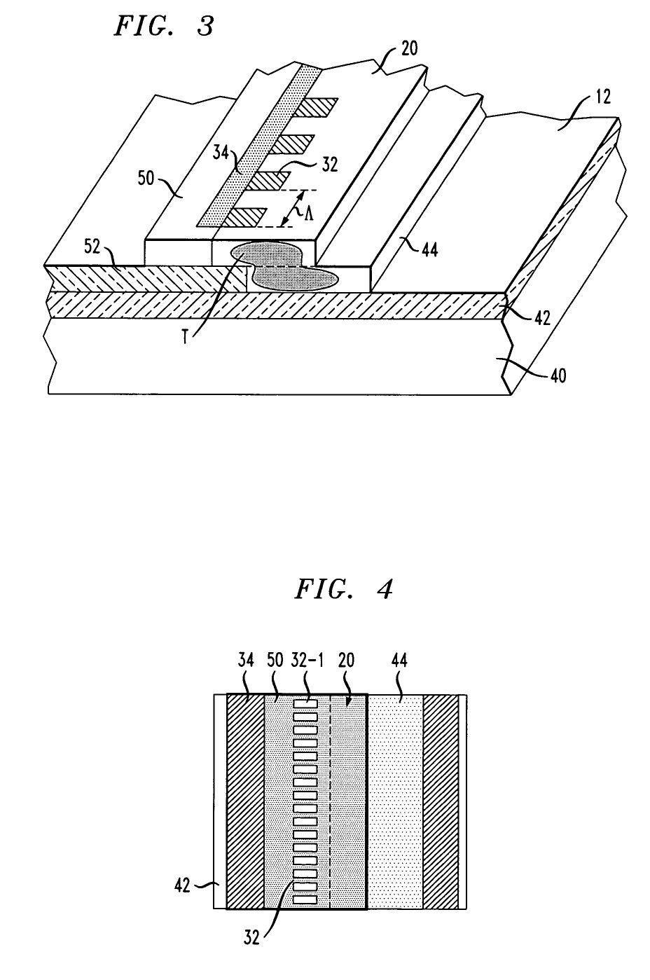

In particular, tunable wavelength selective element 30 comprises tunable Bragg grating structure 32 disposed off-set from waveguide 20 so as to reduce the effect of the grating on the propagating optical mode. The off-set location is determined such that grating structure 32 is located to overlap an evanescent tail region of the propagating optical signal. As will be discussed in detail below, grating structure 32 comprises a plurality of oxide regions as grating elements, where the combination of silicon and oxide results in a grating with a strong contrast ratio (i.e., difference in refractive index values). The use of oxide as grating elements (in contrast to prior art arrangements that utilize polysilicon or another material) allows for conventional CMOS etching, deposition and chemical-mechanical planarization (CMP) processes to be used to form a grating with well-controlled parameters. The strong contrast ratio allows for the grating to be offset from the central portion of the waveguide (overlapping the evanescent tail region) and still encounter a sufficient amount of optical energy to perform the required reflecting of the center wavelength. As will be shown below, grating structure 32 may comprise a single offset grating, as shown in FIGS. 1 and 2, or a pair of gratings disposed on either side of waveguide 20 (see, for example, FIG. 3).

Referring back to FIG. 1, wavelength selective element 30 further comprises a thermally conductive strip 34, disposed adjacent to grating structure 32. Thermally conductive strip 34 may comprise, for example, a strip of metal, doped silicon or silicide. When an electrical current is passed through thermally conductive strip 34, the temperature of strip 34 will increase as a function of the electrical current level and the sheet resistance of strip 34. The change in temperature will quickly propagating into the silicon portion of grating structure 32 and thus change the refractive index value of the silicon portion of the grating. As a result, therefore, the center wavelength of grating structure 32 will change (i.e., be “tuned”) as a function of the current applied to thermally conductive strip 34. Control electronics 36 is used to generate and apply an electrical current to strip 34, where the value of the applied current is adjusted to “tune” the center wavelength reflected by grating structure 32.

It is important that the reflected signal be in phase with the signal propagating through optical gain medium 14 (i.e., constructive interference) so that the signals “add” and are amplified with the cavity portion of ECL 10. To this end, a tunable phase matching element 31 is disposed along waveguide 20 between optical coupling region 18 and wavelength selective element 30 to adjust the phase of the reflected signal until it matches the phase of the signal within the laser cavity. As with wavelength selective element 30, tunable phase matching element 31 can be controlled (either thermally or by free carriers) to modify the optical path length and provide phase tuning/matching.

Simulations have shown that a single mode rib waveguide 20 formed with a cross-section on the order of 0.1 μm² can be thermally tuned in a very efficient manner, on the order of 0.015 mW/° C./μm. Depending on the required wavelength selectivity, grating 32 may comprise a length anywhere in the range of 2-500 μm, with a nominal value of approximately 20 μm. Presuming that the default center wavelength of filter element 30 is 1550 μm, and a tuning range Δλ of about 31 nm is desired, a change in refractive index (ΔN) for grating element 32 of about 2% is required. In silicon, ΔN is approximately 1.6×10⁴/° C. In order to obtain a 2% change in the index of silicon, a localized temperature gradient of approximately 440° C. At 0.015 mW/° C./μm and a Bragg grating of length 20 μm, this results in a power dissipation of approximately 132 mW. Therefore, for a tunability of 31 nm, a power of 132 mW is required for the needed thermal control. A programmable current source 38 within control electronics 36 may be used to deliver a variable current to strip 34, where the generated heat is defined as the multiplicative product of the delivered current (I) and the resistance (R) of strip 34.

FIG. 2 illustrates an alternative embodiment of an ECL formed in accordance with the present invention, where in this example, tunable wavelength selective element 30 comprises a waveguide coupler 40 disposed alongside of waveguide 20 to out-couple a propagating signal and direct the signal into a Bragg reflector grating structure 42, offset in accordance with the present invention from the central waveguiding portion of coupler 40. Similar to grating structure 32 discussed above, reflector grating structure 42 comprises a plurality of oxide grating elements disposed to define a desired grating period, using an associated thermally conductive strip 44 to supply heat to grating structure 42 when desired to adjust its center wavelength.

FIG. 3 is a cut-away isometric view of an exemplary wavelength selective element formed in accordance with the present invention. As evident in this view, SOI structure 12 is shown as comprising a silicon substrate 40, an overlying oxide insulating layer 42 (often referred to in the art as a “buried oxide layer”) and a surface single crystal silicon layer 44 (often referred to in the art as an “SOI layer”). This particular structure includes an overlying, overlapping silicon layer 50 (which may comprise polysilicon or any other suitable form of silicon), where the overlapping region of SOI layer 44 and silicon layer 55 defines the confinement area for a sub-micron dimensioned waveguiding region, as fully described in U.S. Pat. No. 6,845,198 issued to R. K. Montgomery et al. on Jan. 18, 2005 and assigned to the assignee of this case. Grating structure 32 is formed within topmost silicon layer 50 in the manner shown, off-set from the central portion (designated 20-C) of waveguide 20. In particular, grating structure 32 is positioned to encounter the evanescent tail region (denoted T) of the propagating optical mode.

As shown, grating structure 32 comprises a series of grating elements 33 of an oxide (presumably the same type of oxide as used to form insulating layer 52 underneath topmost silicon layer 50) deposited along a portion of silicon layer 50. The spacing between adjacent grating elements 33, denoted A, is defined as the period of grating structure 32. The reflected wavelength within the Bragg grating is denoted by the formula λ=2*n_{eff}*Λ, where n_{eff} is the effective index of the waveguide within the Bragg grating structure. As mentioned above, the refractive index of silicon is approximately 3.5 and the refractive index of silicon dioxide is approximately 1.5, resulting in a large, strong refractive index contrast between these two regions. With this index contrast of approximately 2, if the grating structure is placed in the core of the waveguide, a significant amount of light scattering will occur, making the grating structure highly inefficient for this application. Grating structure 32 may therefore be offset from waveguide 20 so as to overlap only the “tail” portion of the optical mode, yet capture a sufficient amount of optical energy to provide the necessary filtering, due to the strong contrast. A fiber Bragg grating has a nearly 100% overlap with an index contrast of 0.01, whereas the silicon offset Bragg grating of the present invention can be configured for a 0.1-10.0% overlap with an index contrast of approximately 2. FIG. 4 is a top view of the arrangement of FIG. 3, illustrating in particular the disposition of thermally conductive strip 34.

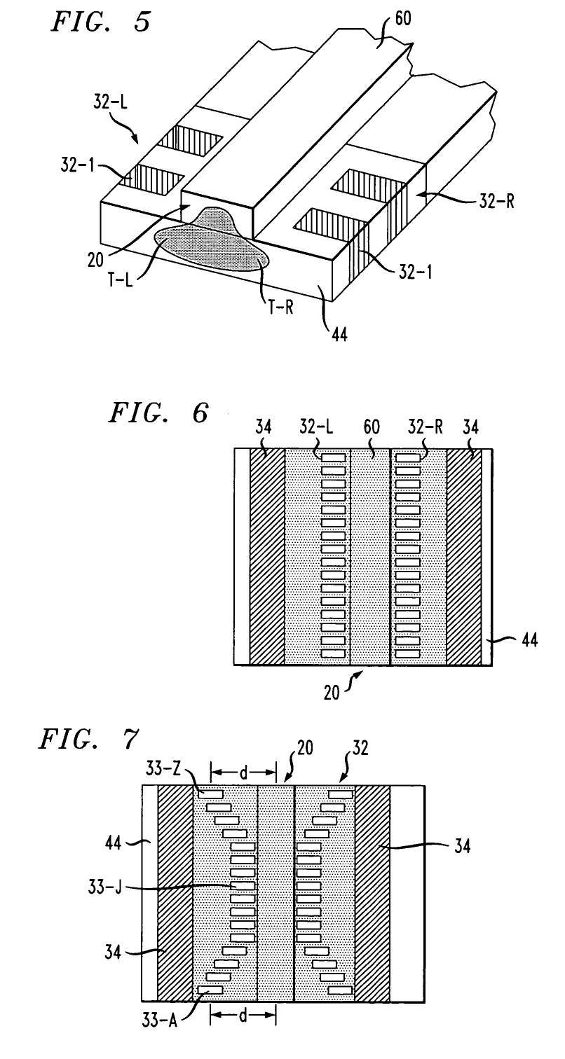

FIG. 5 illustrates an alternative embodiment of the present invention, in this case utilizing a pair of grating structures disposed in an off-set configuration on either side of waveguide 20. In this arrangement, waveguide 20 comprises a portion of SOI layer 44 and an overlying slab silicon component 60. Waveguide selective element 30 takes the form of a first grating structure, denoted 32-L disposed on the left-hand side of waveguide 20 (in the orientation of FIG. 4) and a second grating structure, denoted 32-R disposed on the right-hand side of waveguide 20. As shown, each of these grating structures is disposed over an evanescent tail portion of the propagating optical mode. FIG. 6 is a top view of the structure of FIG. 5.

As mentioned above, it is possible to dispose grating structure 32 of wavelength selective element 30 in an adiabatic configuration. FIG. 7 is a top view of an exemplary adiabatic version of a grating arrangement similar to the arrangement of FIGS. 5 and 6. In particular, grating elements 33 are deposited in a tapering configuration, with a wider separation between first input element 33-A and waveguide 20, and the separation thereafter decreasing adiabatically until grating element 33-J is essentially contiguous with waveguide 20. Thereafter, the remaining grating elements 33 are arranged in an outwardly tapering configuration, where the final grating element 33-Z is separated from waveguide 20 by essentially the same distance as input grating element 33-A. The arrangement as shown in FIG. 7 utilizes a pair of grating structures 32-L and 32-R, each pair exhibiting an adiabatic displacement of grating elements 33. By utilizing an adiabatic arrangement of grating elements, the amount of optical energy that is reflected by the grating (particularly as a result of its strong contrast ratio) is significantly reduced.

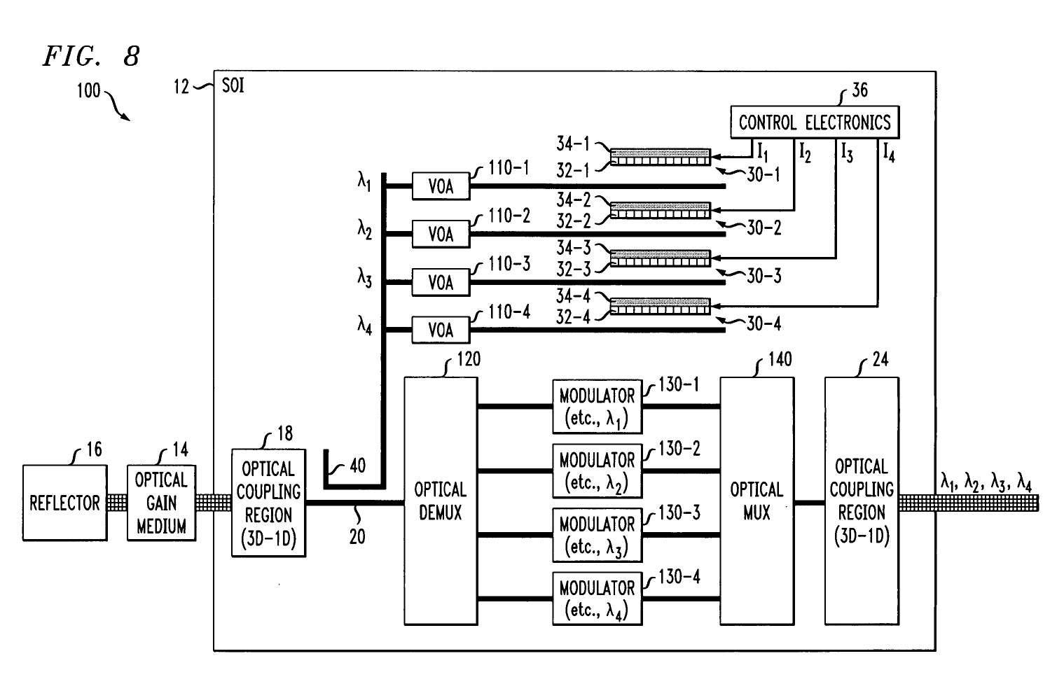

It is also possible to utilization the offset grating, tunable wavelength selective element of the present invention in a WDM arrangement, where a single ECL device is utilized to generate and provide a plurality of output signals operating at different, unique wavelengths. FIG. 8 illustrates one exemplary embodiment of a WDM transmitter 100 utilizing the single ECL device as described above to generate a set of four separate optical transmission signals, denoted as λ₁, λ₂, λ₃ and λ₄. Again, it is a significant aspect of the present invention that all of the various components required to generate the separate transmission signals are formed as a monolithic component on/within a single SOI structure 12, expect for optical gain medium 14 and reflector 16.

As shown, WDM transmitter 100 includes optical couplers 18 and 24, as discussed above, as well as optical waveguide 20 and control electronics 36. In this embodiment, coupling waveguide 40 is again used to out-couple the optical signal created by the ECL device and, in this case, apply the input to a set of four separate variable optical attenuators (VOAs) 110-1, 110-2, 110-3 and 110-4. Each VOA 110 is coupled to a different tunable wavelength selective element 30. Tunable wavelength selective element 30-1, for example, comprises a reflective waveguide section 31, an offset grating structure 32-1 and a thermally conductive tuning strip 34-1. A current I-1, supplied by control electronics 36 is used to “tune” the center wavelength of element 30-1 so as to reflect a pre-defined wavelength λ₁. Tunable wavelength selective elements 30-2, 30-3 and 30-4 function in a similar manner, each utilizing an offset grating configuration of the present invention, to reflect a slightly different transmission wavelength, all wavelengths within the bandwidth of that possible using a single ECL device.

As shown in FIG. 8, the various signals all propagating along waveguide 20 are thereafter applied as an input to an optical demultiplexer 120, which functions to separate the various signals and apply each signal to its associated modulator 130 to form the actual data transmission signals. Thereafter, each modulated signal is re-combined in an optical multiplexer 140 and passed through optical coupling element 24 to form a three-dimensional, free-space optical output signal.

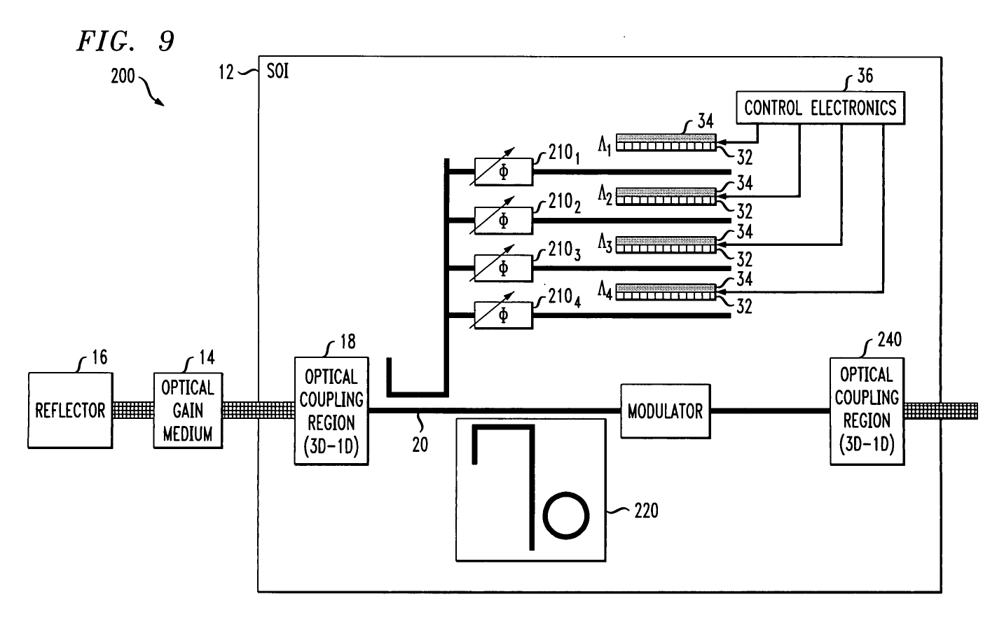

An alternative WDM transmitter 200 formed in accordance with the present invention is illustrated in FIG. 9, where a plurality of phase control elements 210 are utilized to extend the available tuning range of the ECL device. In this embodiment, the period Λᵢ of each Bragg grating 32ᵢ is a different value such that the grating periods are slightly offset from one another. For example, period Λ₁ for grating 32ᵢ may be nominally designed to provide a center wavelength of 1530 nm, period Λ₂ for grating 32₂ designed for a center wavelength of 1540 nm, period Λ₃ for grating 32₃ designed for a center wavelength of 1550 nm, and period Λ₄ for grating 32₄ designed for a center wavelength of 1560 nm. As a result of this center wavelength spacing, each individual Bragg grating need only provide an excursion of 10 nm to obtain the desired 31 nm complete tuning range. Therefore, the local temperature excursion required for each tuning element 34 is similarly decreased, improving the reliability of the overall system. More particularly, the local temperature drops from approximately 440° C. to approximately 150° C.—a temperature that is compatible with the utilization of conventional metallizations (which cannot withstand the extreme temperature of 440° C.).

To select an individual lasing wavelength, for example, 1555 nm, grating 32₃ would be thermally tuned via element 34₃ until the “effective” period Λ₃ provides this center wavelength value. Phase tuning element 210₃ is then tuned to provide in-phase, constructive interference for this wavelength. Remaining phase tuning elements 210₁, 210₂, and 210₄ would be tuned to provide destructive interference at their corresponding center wavelengths to prevent crosstalk, allowing only the signal at wavelength 1555 nm to propagate through the system. A tunable ring resonator structure 220, also formed within the same SOI structure 12 as WDM transmitter 200, may be used as a wavelength selective filter to measure the output signal and ensure proper operation. Ring resonator structure 220 is utilized as a feedback control element that is used to sweep through the complete wavelength range so that only the desired wavelength is present.

In the foregoing detailed description, the structure of the present invention has been described with reference to specific exemplary embodiments thereof. It will, however, be evident that various modifications and changes may be made thereto without departing from the broader spirit and scope of the present invention. The specification and figures are accordingly to be regarded as illustrative rather than restrictive.

What is claimed is:

1. A tunable external cavity laser comprising:
a first reflective endface;
a gain medium; and
a silicon-on-insulator (SOI) substrate supporting
an optical waveguide formed within a surface layer thereof (SOI layer), the optical waveguide including a reflective surface thereby forming a laser cavity with the first reflective endface and the gain medium; and
a grating structure disposed adjacent to, and offset from, the optical waveguide so as to intercept an evanescent tail portion of an optical propagating signal and reflect a predetermined wavelength λ defined as the emitting wavelength of the external cavity layer, the grating structure comprising deposited sections of silicon dioxide as grating elements, with adjacent grating elements separated by a predetermined amount to provide the desired grating period Λ; and
a thermally conductive element disposed adjacent to the grating structure for modifying the temperature of the grating structure sufficiently to change the refractive index and adjust the value of the selectively filtered wavelength.

2. A tunable external cavity laser as defined in claim 1 wherein the optical waveguide comprises an overlapped configuration of the SOI layer and an overlying silicon layer, the overlapped portion forming a sub-micron dimensioned optical waveguide.

3. A tunable external cavity laser as defined in claim 2 wherein the grating structure is formed within the overlying silicon layer.

4. A tunable external cavity laser as defined in claim 2 wherein the grating structure is formed within the SOI layer.

5. A tunable external cavity laser as defined in claim 2 wherein the grating structure comprises a first grating formed within the overlying silicon layer and a second grating formed within the SOI layer.

6. A tunable external cavity laser as defined in claim 1 wherein the optical waveguide comprises a rib waveguide formed along the SOI layer.

7. A tunable external cavity laser as defined in claim 6 wherein the grating structure is formed within the SOI layer.

8. A tunable external cavity laser as defined in claim 1 wherein the grating elements are adiabatically disposed along the optical waveguide so as to reduce optical reflections.

9. A tunable external cavity laser as defined in claim 1 wherein the thermally conductive strip comprises a silicide strip and the laser further comprises
an adjustable current source, coupled to the silicide strip, to cause a current to flow through the silicide strip and increase the temperature of the strip and the adjacent grating structure, the temperature increase defined as a function of the electrical current value and the resistance of the silicide strip.

10. A tunable external cavity laser as defined in claim 1 wherein the thermally conductive strip comprises a metallic strip and the laser further comprises
an adjustable current source, coupled to the metallic strip, to cause a current to flow through the metallic strip and increase the temperature of the strip and the adjacent grating structure, the temperature increase defined as a function of the electrical current value and the resistance of the metallic strip.

11. A WDM transmitter for providing a plurality of optical signals at different wavelengths, the transmitter comprising
a tunable external cavity laser including:
a first reflective endface;
a gain medium; and
a silicon-on-insulator (SOI) substrate supporting
an optical transmission waveguide formed within a surface layer thereof (SOI layer) and coupled to receive the output from the laser gain medium;
an optical coupling waveguide, disposed to out-couple a portion of the signal propagating through the optical transmission waveguide;
a plurality of optical tap waveguides disposed along the extent of the optical coupling waveguide, the plurality of optical tap waveguides each including a reflective end surface thereby forming a laser cavity with the first reflective endface and the gain medium; and
a plurality of grating structures disposed adjacent to, and offset from, the plurality of optical tap waveguides in a one-to-one relationship so as to intercept an evanescent tail portion of a propagating optical signal and reflect a predetermined wavelength λ defined as the emitting wavelength of the external cavity layer, the grating structure comprising deposited sections of silicon dioxide as grating elements, with adjacent grating elements separated by a predetermined amount to provide the desired grating period A; and
a plurality of thermally conductive elements disposed adjacent to the plurality of grating structures in a one-to-one relationship for modifying the temperature of the associated grating structure sufficiently to change the refractive index and adjust the value of the selectively filtered wavelength.

12. A WDM transmitter as defined in claim 11 wherein the WDM transmitter is configured to transmit a single, selected wavelength from a predefined wavelength range, the WDM transmitter further comprising
a plurality of phase tuners associated with the plurality of grating structures in a one-to-one relationship, each grating structure configured to reflect a relatively narrow wavelength range such that collectively the plurality of gratings structures covers the predefined wavelength range, wherein a phase tuner associated with a grating structure reflecting a selected wavelength is adjusted to provide constructive interference and the remaining phase tuners in the plurality of phase tuners are adjusted to provide destructive interference so as to maintain a single, selected wavelength output signal.

13. A WDM transmitter as defined in claim 12 wherein the transmitter further comprises a feedback module for measuring output wavelength, comparing to desired output wavelength and transmitting an adjustment signal to the associated thermally conductive element to adjust the wavelength accordingly.

14. A WDM transmitter as defined in claim 13 wherein the feedback module comprises a ring resonator structure integrated within the SOI substrate adjacent to the optical transmission waveguide.
